(19) United States
(12) Patent Application Publication
(10) Pub. No.: US 2020/0342066 A1
(43) Pub. Date: Oct. 29, 2020

(54) Reducing Latency in Client Side Presentation of Content

(71) Applicant: Google Inc., Mountain View, CA (US)

(72) Inventors: Justin Lewis, Marina del Rey, CA (US); Richard Dominick Rapp, Downey, CA (US)

(21) Appl. No.: 15/219,027

(22) Filed: Jul. 25, 2016

(51) Int. Cl. G06F 17/30; G06F 17/22

(52) U.S. Cl. CPC G06F 17/30882; G06F 17/3053; G06F 17/30014; G06F 17/2235

(57) ABSTRACT

Methods, systems, and apparatus, including computer programs encoded on a computer storage medium, for reducing latency in client side presentation of content. In one aspect, a method includes: receiving a request for content to cache on a client device for subsequent presentation with one or more target documents linked to by a document; identifying an interaction likelihood for each link; determining, for each target document, content types that are eligible to be presented in slots of the target document; identifying, for each content type, target documents that include slots in which the content type is eligible to be presented; determining, for each content type, a presentation likelihood based on an aggregation of the interaction likelihoods of the target documents for that content type; ranking each content type based on the presentation likelihoods; and caching, on the client device, third party content having a highest ranked content type.

### BACKGROUND

This specification relates to reducing latency in client side presentation of content.

A source document, such as a search results page or a social feed, can include links to target documents. For example, the search results page can have links to search result documents and the social feed can have links to articles.

### SUMMARY

In general, one innovative aspect of the subject matter described in this specification can be embodied in.

Particular implementations of the subject matter described in this specification can be implemented so as to realize one or more of the following advantages.

A target document linked to by a source document, such as a search results page or social feed, can be cached in advance of an explicit request for the target document. Third party content that are of content types that are most likely to be presented at a client device can be cached on the client device prior to a request for, or presentation of, a target document. A content serving system can be configured to cache third party content included in a target document on the client device while a source document is presented on the client device, thereby taking advantage of a time period during which the client device, content server computing devices, and/or content sponsor computing devices have available processing capacity. Third party content that are of content types that are most likely to be presented can be provided to a client device in a single response, which can result in fewer network calls, fewer requests sent to a server, and less server processing time, as compared to multiple responses sent responsive to multiple requests for individual content slots included in target documents.

A client device can present third party content included in a target document when opening the target document without having to wait for the third party content to be retrieved following a client-side request for the target document, thereby reducing the latency involved with presentation of the third party content. The reduction of latency can result in a higher degree of user satisfaction with the third party content and the target document. The user can view a target document and third party content included in the target document without having to wait for retrieval of the target document or the third party content.

Presenting cached third party content can result in an increased likelihood that the third party content item will be presented, as compared to requesting third party content after the user selects a link to view a target document. The cached third party content can be available for immediate presentation when the user selects a link to view the target document, whereas if the third party content is retrieved after the user selects the link, content delivery delays may prevent presentation of the third party content or the user may otherwise navigate away from the target document before the third party content is presented.

The increased likelihood that the cached third party content will be presented can increase a value to a sponsor of the third party content due to the sponsor having more confidence that the cached third party content will actually be presented, as compared to approaches that do not use caching. The sponsor may submit a higher bid for or place a higher value on the third party content to a content serving system if the sponsor is aware that the third party content may be cached. The higher values received from the sponsor can result in increased revenue opportunities for a target document publisher and the content serving system.

The increased likelihood that the cached third party content will be presented can result in an increased likelihood of recording of an impression, as compared to approaches that do not use caching. For example, if caching is not performed, there can be an increased likelihood that a network delay or other technical issue prevents the completion of a request for third party content, a subsequent response to the third party content, and/or the recording of an impression. The increase likelihood of the recording of impressions can result in a higher number of recorded impressions, which can result in increased revenue for the target document publisher and the content serving system. The increased likelihood that the cached third party content will be presented can result in an increased likelihood of a conversion associated with the content item. The increased likelihood of a conversion can result in a higher number of recorded conversions, which can result in increased revenue for the target document publisher and the content serving system.

Caching third party content of types that are most likely to be presented can result in more efficient processing as compared to caching third party content of all content types that are included in target documents linked to by a source document. The third party content selected to be cached on the client device can include third party content that is suitable for presentation on multiple different target documents that are linked to by a source document so that fewer instances of third party content need to be cached client side, thereby reducing the amount of data transferred, the amount of bandwidth consumed by the client device, and the amount of power consumed by the client device in caching the third party content, which can extend the battery life of the client device. Caching the most likely to be presented third party content in advance of an explicit request can also save processing time, storage, and data plan usage as compared to also caching other third party content that is not as likely to be presented without an explicit request. Caching the most likely to be presented third party content can result in fewer network calls to third party content providers as compared to also caching other third party content that is not as likely to be presented.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which a content server causes third party content to be cached at a client device.

FIGS. 2-4 each illustrate an example ranking of content types that are eligible to be presented in target documents linked to from a source document.

FIG. 5 is a flow chart of an example process for caching third party content.

FIG. 6 is an example of a computing device and a mobile computing device that may be used to implement the computer-implemented methods and other techniques described herein.

Like reference numbers and designations in the various drawings indicate like elements.

### DETAILED DESCRIPTION

Users of mobile and other client devices desire fast response time when selecting content to view on a client device. For example, a user can request a source document that includes links to a set of target documents that are displayed when the user selects a respective link. To reduce latency when presenting a target document, the target documents can be provided to the client device at the same time that the source document is provided (i.e., before the user explicitly requests the target documents).

As another example, the source document and the target document can include third party content, such as advertisements. To reduce latency when the user selects a link to a target document, third party content included in target documents can be cached on the client device prior to a request for the third party content or for the target documents. However, some approaches for caching third party content can result in undesirable outcomes.

For example, a target document may contain a number of content slots for third party content, and third party content for each content slot in the target document can be selected and cached on the client device before a user explicitly requests to view the target document. Such an approach can result in the presentation of third party content that is specifically selected for each particular content slot (e.g., third party content can be selected based on a match between the content of the target document and a third party content item). Such an approach, however, can result in downloading content items that may never be requested by the user because the user may not select many of the links associated with target documents. Downloading many third party content items can result in a long initial download time for the source document (e.g., if the third party content is downloaded along with the source document and the target documents), tying up network bandwidth for the client device, an increase in power consumption of the client device, and an increase in data plan usage for the client device. Resource consumption and bandwidth issues can be particularly problematic for large content items, such as video content items.

As another example, a set of one or more general third party content items can be selected for caching on the client device before a user requests the items rather than the specific selection of a content item for every possible content slot in the target documents. The general content item(s) can be selected without knowledge of which target document the user may select. Such an approach can result in less data transfer and resource usage but can result in selection of third party content that is not the best match for content slots that are actually displayed to the user.

As discussed in detail below, a content server can determine one or more types of third party content in the target documents that are most likely to be presented to the user and cause content items to be cached on the client device of the determined content types in order to reduce latency associated with presentation of third party content, while also reducing the amount of data downloaded with a search results page or social feed (or another type of document that links to other documents). Content types can include, for example, text, video, image, and/or a content item size (e.g., the dimensions of the content or the data size). The content server can, for example, identify third party content to be cached that is of a content type that appears in multiple target documents and/or appears in target documents that are likely to be selected by the user.

In further detail, a content server can identify, for each target document, a likelihood that the user will interact with a link for the respective target document. The content server can identify a set of content types that are eligible to be presented in third party content slots included in the set of target documents. The content server can determine, for each content type, a presentation likelihood indicating a likelihood that the content type will be presented on the client device based on an aggregation of the interaction likelihoods for the target documents that include a content slot of the respective content type. The content types can be ranked according to presentation likelihoods and one or more portions of third party content can be cached on the client device based on the ranking.

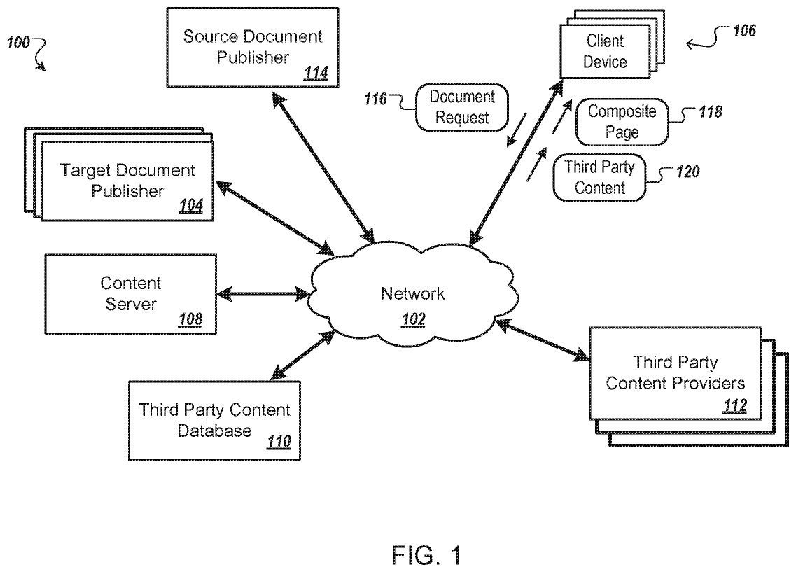

FIG. 1 is a block diagram of an example environment 100 in which a content server 108 causes third party content to be cached at a client device 106. The example environment 100 includes a data communication network 102, such as a local area network (LAN), a wide area network (WAN), the Internet, or a combination thereof. The network 102 enables data communication between multiple electronic devices and systems. In particular, the network 102 connects a plurality of target document publishers 104, a client device 106, a content server 108, a third party content database 110, a plurality of third party content providers 112, and a source document publisher 114. Communications links of the network 102 can be wireline or wireless links or both. Each of the client device 106, content server 108, content database 110, source document publisher 114, and target document publishers 104 may include a respective network interface to enable network communications over the network 102.

As used herein, a source document is a document that includes links to other documents, referred to herein as target documents. A source document can be, for example, a search results page that includes a set of links to search result documents that match a search query. In this example, the source document publisher 114 is a search system and the target document publishers 104 provide target documents linked to by the search results page. As another example, the source document publisher 114 can provide a content feed, such as a social feed that includes links to a set of articles. In this example, the source document is the content feed and the target documents are articles provided by the target document publishers 104.

The client device 106 is an electronic device that is under control of a user and is capable of requesting and receiving resources over the network 102. Example client devices 106 include laptop computers, desktop computers, television devices that are enabled to stream online video content, mobile communication devices (e.g., smart phones, tablet computing devices, netbooks, notebook computers, or wearable devices), and other devices that can send and receive data over the network 102.

The client device 106 typically includes a user application, such as a web browser, that can facilitate the sending and receiving of data over the network 102. For example, the client device 106 can submit a document request 116 to the source document provider 114. The document request 116 can, for example, include a search query and be a request for a search results page. As another example, the document request 116 can be a request for a content feed that includes links to target documents (e.g., articles).

The source document publisher 114 can be configured to create and provide a composite page 118 in response to the document request 116. The composite page 118 includes the requested source document and the target documents that are linked to by the source document. For example, the composite page 118 can include a search results page and search results documents that are linked to by the search results page. In some implementations, the composite page 118 is associated with an accelerated mobile pages (AMP) format. An initial rendering of the composite page 118 can result in a presentation of the source document. A target document included in the composite page 118 can be displayed in response to user interaction a link presented in the source document.

The composite page 118 can be provided to the client device 106 to maintain the user within a single application (e.g., a search engine page or a feed reader) in order to improve the user experience by reducing the transition time of switching between documents. Latencies caused by making multiple requests for documents over the network 102 can be reduced by aggregating the source document and linked-to target documents into the composite page 118. For example, the number of client device 106 initiated network calls (or requests) required to render and present the composite page 118 at the client device 106 will generally be lower than the number of network calls the client device 106 would need to make to separately obtain, render, and present the content from the source document and selected target documents.

The target documents included in the composite page 118 can include content slots in which third party content is eligible to be presented. To further reduce latency, third party content 120 to be presented in content slots in the target documents can be provided to and cached on the client device 106. For example, the content server 108 can receive a request for third party content from the source document publisher 114.

The content server 108 (or the source document publisher 114) can identify, for each link in the source document, an interaction likelihood that indicates a likelihood that a user will interact with the particular link when presented in the source document. For example, a click through rate (CTR) can be identified for each link, based on historical user interaction data that indicates a frequency at which each link has been selected for past presentations of the source document. This interaction likelihood may be presented, for example, as a ratio or a percentage.

The content server 108 (or the source document publisher 114) can determine, for each target document linked to by the source document, one or more content types that are eligible to be presented in slots of the particular target document. Content types can include, for example, text content, image content, video content, audio content, content item size, type of content network from which the content is received, or location within the respective target document.

Content types that are eligible to be included in a target document can be determined, for example, by analyzing the content of the target document to identify content slots in the target document. Some or all of the content slots can be associated with a content type tag that indicates the content type that is eligible to be presented in a respective content slot, for example. A set of content types associated with a target document can be determined by identifying the content type tags that are included in the target document. As another example, content types associated with the target document can be determined by looking up the target document in a pre-populated mapping database that maps target document references to a set of content types.

Multiple, different content types can be eligible to be presented in the slots of the set of target documents, for example, and the content server 108 can determine third party content of one or more particular content types to be cached on the client device 106. For example, the content server 106 can determine which content types are most likely to be presented on the client device 106 when the user views the source document and selects one or more links to view one or more target documents.

The content server 108 can determine a presentation likelihood for each content type that is eligible to be presented in one or more of the target documents. The presentation likelihood is a value that indicates a likelihood that the user will select a target document in which the content type is eligible to be presented. This presentation likelihood may be presented, for example, as a ratio or a percentage. The presentation likelihood for a content type can be an aggregation of the interaction likelihoods of the target documents in which the content type is eligible to be presented. The content server 108 can rank the content types based on the presentation likelihoods of the content types. Presentation likelihoods and ranking are described in more detail below.

The content server 108 can cause one or more portions of third party content 120 to be cached on the client device 106, prior to user interaction with any of the links included in the source document, so that the portions of third party content are available for display with a respective target document without a need for a separate request for or download of the third party content. Caching can include, for example, caching content items that are content types that have presentation likelihoods greater than a predetermined threshold. As another example, caching can include caching multiple content items in an order corresponding to the presentation likelihoods of the content types of the multiple content items.

In some implementations, the content server 108 can select the one or more portions of third party content based on an auction. Content items can be selected, for example, based on a score that is based on an estimated selection rate (e.g., click through rate) of a content item, a value placed on the content item by a sponsor, and a quality score of the content item. A quality score can represent an overall quality of a content item and an impact of presenting the content item to the user. Content items that are content types that have presentation likelihoods greater than the predetermined threshold can have quality scores that are higher than content items that are of other content types, which can result in the content items that are content types that have presentation likelihoods greater than the predetermined threshold being selected for caching on the client device 106.

The content server 108 can send the selected third party content 120 to the client device 106, in response to the document request 116. In some implementations, the content server 108 sends the selected third party content 120 in an ordered format. For example, third party content items can be ordered by presentation likelihood or by a quality score or other score. The ordered content items can be included in or referenced by an ordered data structure, such as an ordered list.

The composite page 118 can be configured to select a received content item from the ordered data structure for each content slot in a particular target document in response to the user selecting a link to view the particular target document. The content server 108 can send metadata with each content item, for example. The metadata can include content slot types (e.g., content slot size, format) in which the content item can be displayed. In some implementations, the metadata includes content slot identifiers which indicate content slots in which the content item can be displayed. The composite page 118 can be configured to remove a particular content item from the ordered data structure (or otherwise mark the particular content item as no longer available) once the particular content item has been presented to the user.

As another example, the content server 108 can select and send to the client device 106 an ordered list of content items for each content slot in target documents that is of content types that have presentation likelihoods that are greater than the predefined threshold. The ordered list for a content slot can be ordered, for example, by presentation likelihood, quality score, or overall auction score. The composite page 118 can be configured to select a content item for a target document content slot from the ordered list of content items for that content slot, when the user selects a link to the target document. The composite page 118 can be configured to remove the presented content item from the ordered list of content items for the content slot (or otherwise mark the content item as no longer available). If the target document is presented again, the composite page 118 can select another content item from the list of ordered content items for the content slot, for presentation in the content slot.

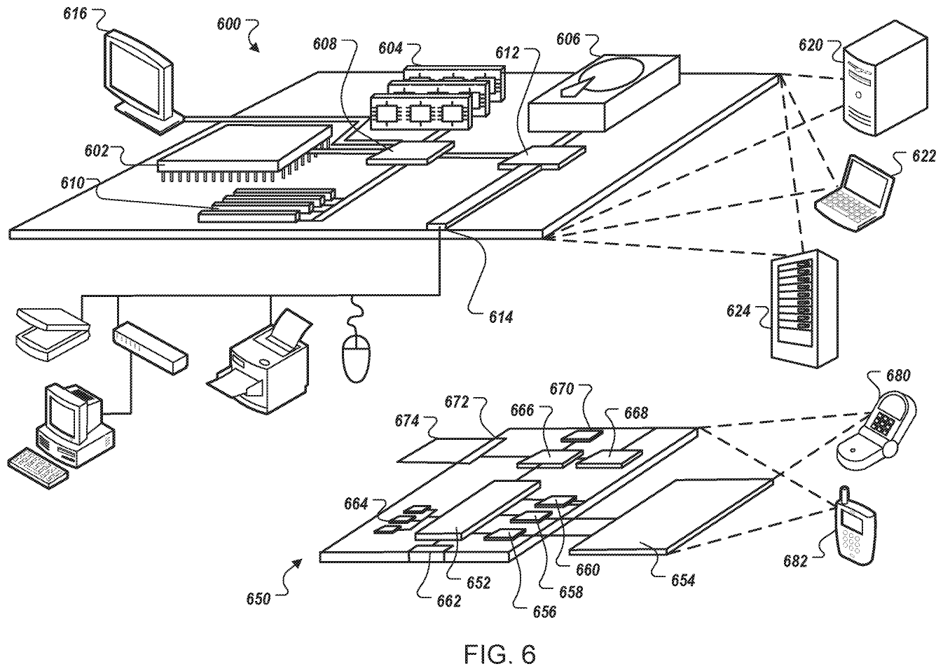

The content server 108, third party content database 110, source document publisher 114, and target document publishers 104 may include laptops, desktops, workstations, personal digital assistants, servers, blade servers, mainframes, and other appropriate computers. Servers may generally comprise a collection of one or more computers and may perform processing across the one or more computers in one or more geographically separated locations. Each of the content server 108, third party content database 110, source document publisher 114, and target document publishers 104 may generally be implemented as a combination of hardware and software of one or more computers in one or more locations, such as computers described with respect to FIG. 6.

Although described as being implemented on the content server 108, in some implementations, the determination of presentation likelihoods for content types and the ranking of content types can be performed on the client device 106. The content server 108 can provide the interaction likelihoods for the target documents to the client device 106, for example, with the composite page 118 that includes the source document and the target documents. The client device 106 can determine the presentation likelihoods of the content types included in the target documents and rank the content types based on the presentation likelihoods upon receipt of the interaction likelihoods for the target documents. The client device 106 can request, from the content server 108, one or more content items, based on the ranking, to increase the likelihood that the requested content items are cached on the client device 106 by the time the user views a target document that includes a respective requested content item. Although shown as a single server, in some implementations, functionality of the content server 108 can be performed by multiple servers. For example, a front-end content server can receive a request for content to cache on the client device 106, the front-end server can send a request to a second server to determine third party content types that are most likely to be presented, and the content server 108 can select content of the content types that are most likely to be presented.

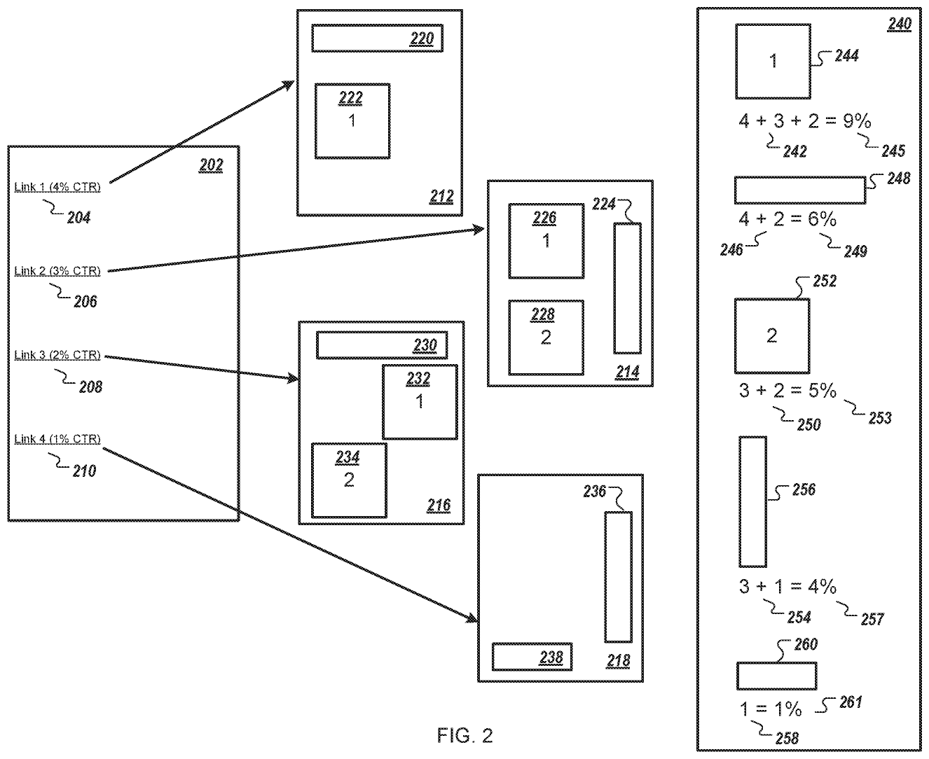

FIG. 2 illustrates an example ranking of content types that are eligible to be presented in target documents linked to from a source document 202. The source document 202 includes a set of links 204, 206, 208, and 210, linking to target documents 212, 214, 216, and 218, respectively. An interaction likelihood (e.g., click through rate (CTR)) can be determined for each link 204, 206, 208, and 210. For example, interaction likelihoods of 4%, 3%, 2%, and 1% can be determined for the links 204, 206, 208, and 210, respectively, such as based on historical user interaction data.

Each target document 212, 214, 216, and 218 includes content slots for particular types of content items. For example, the target document 212 includes a content slot 220 for a first content type (e.g., represented by a horizontal rectangle shape) and a content slot 222 for a second content type (e.g., represented by a square shape). The target document 214 includes a content slot 224 for a third content type (e.g., represented by a vertical rectangle shape) and content slots 226 and 228 for the second content type (e.g., represented by two square shapes).

In some implementations, if a target document includes multiple slots for a same type of content, the content type for a given slot can be augmented with an index number to create a new content type to distinguish the multiple slots from one another. An index number can indicate a location in the associated target document of a content slot of a given content type. For example, the content slots 222 and 226 are designated with an index of one, indicating a first occurrence of the second content type within the target document 212 or target document 214, respectively, and the content slot 228 is designated with an index of two, indicating a second occurrence of the second content type within the target document 214.

The target document 216 includes a content slot 230 of the first content type and content slots 232 and 234 (designated with indices of one and two, respectively) of the second content type. The target document 218 includes a content slot 236 of the third content type and a content slot 238 of a fourth content type.

A presentation likelihood can be determined for each of the five content types based on an aggregation of the interaction likelihoods of the target documents 212, 214, 216, or 218 that include a slot in which a respective content type is eligible to be presented. For example, in a results area 240, a formula 242 displayed with a representation 244 of the second content type with index of one indicates that a first occurrence of the second content type has a presentation likelihood 245 of 9%. The 9% value is an aggregation of the 4%, 3%, and 2% interaction likelihoods for the links 204, 206, and 208 that link to the target documents 212, 214, and 216 in which the second content type is eligible to be included, respectively.

A formula 246 displayed with a representation 248 of the first content type indicates that the first content type has a presentation likelihood 249 of 6%. The 6% value is an aggregation of the 4% and 2% interaction likelihoods for the links 204 and 208 that link to the target documents 212 and 216 in which the first content type is eligible to be included, respectively.

A formula 250 displayed with a representation 252 of the second content type with index of two indicates that a second occurrence of the second content type has a presentation likelihood 253 of 5%. The 5% value is an aggregation of the 3% and 2% interaction likelihoods for the links 206 and 208 that link to the target documents 214 and 216 in which two instances of the second content type are eligible to be included, respectively.

A formula 254 displayed with a representation 256 of the third content type indicates that the third content type has a presentation likelihood 257 of 4%. The 4% value is an aggregation of the 3% and 1% interaction likelihoods for the links 206 and 210 that link to the target documents 214 and 218 in which the third content type is eligible to be included, respectively.

A formula 258 displayed with a representation 260 of the fourth content type indicates that the fourth content type has a presentation likelihood 261 of 1%. The 1% value corresponds to the 1% interaction likelihood for the link 210 that links to the target document 218 in which the fourth content type is eligible to be included (the target document 218 is the only example target document that includes a content slot for the fourth content type).

The results area 240 includes the presentation likelihoods 245, 249, 253, 257, and 261 for the content types in a ranking from largest to smallest (as displayed top-to-bottom). The content server 108 can use the ranking of the content types by presentation likelihoods to determine types of third party content to cause a client device to cache in response to a request for third party content. For example, the content server 108 can determine a highest ranked content type (e.g., the second content type with index of one) and can cause a content item of the highest ranked content type to be cached on the requesting client device, prior to user interaction with any of the links 204, 206, 208, and 210. As another example, the content server 108 can determine the N highest ranked content types and cache a content item for each of the N highest ranked content types (where N is a positive integer greater than one). As yet another example, the content server 108 can determine content types that have a presentation likelihood greater than a threshold and cache at least one content item for each of those content types.

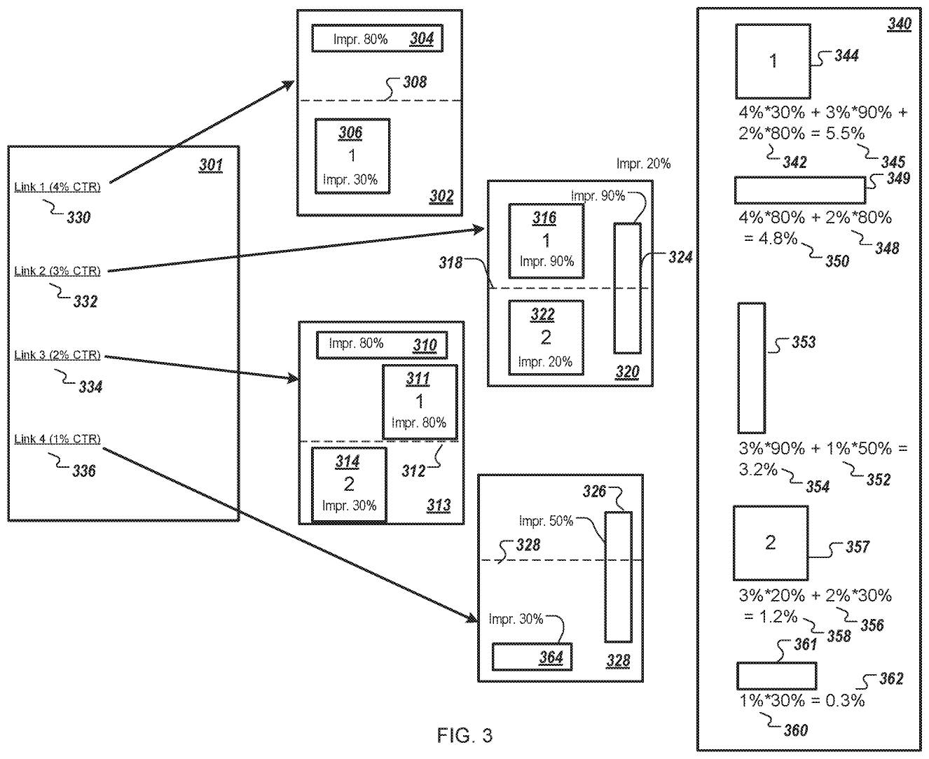

FIG. 3 illustrates an example ranking of content types that are eligible to be presented in target documents linked to from a source document 301. In some implementations, a presentation likelihood for a content type can be based on interaction likelihoods for target documents that include a content slot in which a content item of the content type can be presented as well as impression likelihoods for the content slots which indicate a likelihood that a user will be displayed content in a given content slot when they view a target document that includes the given content slot. For instance, if a given target document includes a lot of information that requires a user viewing the target document to scroll down to view all of the target document, there is a higher likelihood that the content near the top of a page will be displayed than the content near the bottom of the page because the content near the bottom of the page requires additional user action (e.g., paging down or scrolling) to be displayed.

For example, a target document 302 includes a content slot 304 for a first content type and a content slot 306 for a second content type. An impression likelihood for the content slot 304 can be determined to be 80% (e.g., shown as “Impr. 80%”). The content slot 302 is above a fold line 308, for example, so the content slot 304 will be visible after the target document 302 loads. However, there is a chance that the user will scroll the target document 302 before having adequate time to view the content slot 304 to treat an initial view of the content slot 302 as an impression. Accordingly, the impression likelihood of 80% for the content slot 304 indicates that the user is likely, but not certain, to view the content slot 304. As another example, the content slot 306 is below the fold line 308. The user can view the content slot 306 if the user scrolls the target document 302. An estimated impression likelihood for the content slot 306 is lower (e.g., 30%) than the impression likelihood for the content slot 304.

An estimated impression likelihood for content slots above (or below) a fold line can be the same for all target documents or can be specific to a given target document. For example, if the content server 108 is configured to determine general impression likelihoods for content slots above and below a fold line that apply to all target documents, impression likelihoods for content slot 310 for the first content type and content slot 311 for the second content type that are above a fold line 312 in a target document 313 can be the same (e.g., 80%) as the impression likelihood for the content slot 304. Similarly, an impression likelihood for a content slot 314 for the second content type that is below the fold line 312 can be the same (e.g., 30%) as the impression likelihood for the content slot 306.

If the content server 108 is configured to determine impression likelihoods that are specific to a given target document (e.g., based on historical user interaction data (e.g., scrolling) associated with the given target document), then an impression likelihood for a content slot 316 that is above a fold line 318 in a target document 320 can be different (e.g., higher, 90%) than the impression likelihood for the content slot 311. For example, historical user interaction data can indicate that on average, users tend to scroll the target document 320 less than the target document 313. Accordingly, the content slot 316 may generally be visible to users for a longer time (and thus more likely to have an impression) than the content slot 311. Moreover, a content slot 322 that is below the fold line 318 can have a different (e.g., lower, 20%) impression likelihood than the content slot 314 (e.g., due to the lesser amount of scrolling generally performed for the target document 320 as compared to the target document 313).

In some implementations, when a content slot 324 is partially above the fold line 318, an impression likelihood for the content slot 324 is the same (e.g., 90%) as for the content slot 316 that is above the fold line 324. In some implementations, a content slot is considered to be above the fold line when at least a threshold portion of the content slot is above the fold line. In some implementations, an impression likelihood for a content slot that is partially above a fold line is a percentage of an impression likelihood of a content slot that is entirely above the fold line. For example, a content slot 326 that is partially above a fold line 328 has an impression likelihood of 50%, which is less than the impression likelihoods of the content slots 304, 310, 311, and 316 that are above respective fold lines.

Other approaches for determining impression likelihoods can be used. For example, different content slots for different content types can have different impression likelihoods (e.g., a video content item may be more likely to be viewed by a user than an image content item, and an image content item may be more likely to be viewed than a text content item).

Once the content server 108 has determined or identified impression likelihoods for the content slots included in the target documents 302, 313, 320, and 328, the content server 108 can determine presentation likelihoods for the content types that are eligible to be presented in the target documents 302, 313, 320, and 328, based on the impression likelihoods for the content slots and on interaction likelihoods for links 330, 332, 334, and 336 included in the source document 301 that respectively link to the target documents 302, 313, 320, and 328.

For example, in a results area 340, a formula 342 displayed with a representation 344 of the second content type with index of one indicates that a first occurrence of the second content type has a presentation likelihood 345 of 5.5%. The content server 108 can, for each target document 302, 313, 320, and 328 that includes a content slot in which the second content type is eligible to be presented, multiply the interaction likelihood for the respective target document by the impression likelihood for the first content slot in the respective target document in which the second content type is eligible to be presented. As shown in the formula 342, the 5.5% presentation likelihood 345 for the first occurrence of the second content type can be computed by adding together i) the interaction likelihood of 4% for the link 330 times the impression likelihood of 30% for the content slot 306; ii) the interaction likelihood of 3% for the link 332 times the impression likelihood of 90% for the content slot 316; and iii) the interaction likelihood of 2% for the link 334 times the impression likelihood of 80% for the content slot 311.

Presentation likelihoods for other content types that are eligible to be presented in the target documents 302, 313, 320, and 328 can be computed in a similar manner. The presentation likelihoods displayed in the results area 340 can be used to cache content items of content items associated with content slots having highest ranked presentation likelihoods, as described above.

As examples of other computations, as shown in a formula 348 displayed with a representation 349 of the first content type, a 4.8% presentation likelihood 350 for the first content type can be computed by adding together i) the interaction likelihood of 4% for the link 330 times the impression likelihood of 80% for the content slot 304; and ii) the interaction likelihood of 2% for the link 334 times the impression likelihood of 80% for the content slot 310. As shown in a formula 352 displayed with a representation 353 of the third content type, a 3.2% presentation likelihood for the third content type can be computed by adding together i) the interaction likelihood of 3% for the link 332 times the impression likelihood of 90% for the content slot 324; and ii) the interaction likelihood of 1% for the link 336 times the impression likelihood of 50% for the content slot 326.

As shown in a formula 356 displayed with a representation 357 of a second occurrence within a target document of the second content type, a 1.2% presentation likelihood 358 for the second occurrence of the second content type can be computed by adding together i) the interaction likelihood of 3% for the link 332 times the impression likelihood of 20% for the content slot 322; and ii) the interaction likelihood of 2% for the link 334 times the impression likelihood of 30% for the content slot 314. As shown in a formula 360 displayed with a representation 361 of the fourth content type, a 0.3% presentation likelihood 362 for the fourth content type can be computed by multiplying the interaction likelihood of 1% for the link 336 times the impression likelihood of 30% for a content slot 364.

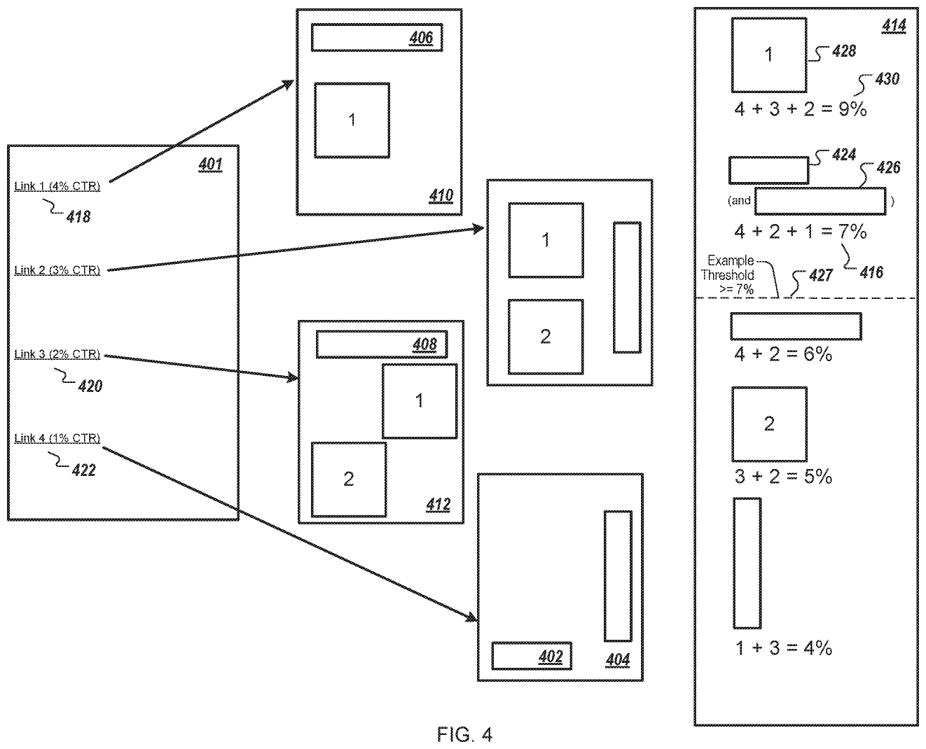

FIG. 4 illustrates an example ranking of content types that are eligible to be presented in target documents linked to from a source document 401. In some implementations, a content item can be configured to be presented in content slots of different types. For example, a text content item can be configured to be presented in content slots of different sizes (the content item can be displayed in fonts of different sizes in different-sized content slots, or the content item can be otherwise configured to be presented in different-sized or other types of slots). Content items can be cached based on a ranking that is an aggregation of presentation likelihoods of the different types of content slots in which a content item is eligible to be presented.

For example, suppose that a content item configured to be displayed in a content slot 402 of a first content type in a target document 404 is also configured to be able to be displayed in content slots 406 and 408 of a second content type included in target documents 410 and 412, respectively. Content slots 406 and 408 are a different size than content slot 402, but the content item is nonetheless configured to be displayed in any of content slots 402, 406, and 408. As shown in a results area 414, an aggregate presentation likelihood 416 of 7% for the first content type can be computed as a sum of interaction likelihoods of 4%, 2%, and 1% of links 418, 420, and 422 in the source document 401 that link to the target documents 410, 412, and 404, respectively. The target documents 410, 412, and 404 each include a content slot for either the first or second content type.

A representation 424 of the first content type and a representation 426 of the second content type displayed in the results area 414 next to the aggregate presentation likelihood 416 illustrate that the aggregate presentation likelihood 416 for the first content type is based on likelihoods of either the first or second content types being presented when a user selects a link in the source document 401. As described above, content items can be cached based on a ranking of presentation likelihoods displayed in the results area 414. For example, the content server 108 can be configured to cache a content item of each content type having a presentation likelihood equal to or greater than a predefined threshold likelihood of 7% 427. The content server 108 can cache, on a client device, a content item of a third content type represented by a shape 428 based on a presentation likelihood 430 for the third content type being greater than the threshold likelihood. The content server 108 can also cache a content item of the first content type based on the aggregate presentation likelihood 416 being greater or equal to the threshold likelihood.

Other approaches can be used for caching content. For example, the content server 108 can determine, for a set of target documents that are linked to by a source document, that a particular content item occurs in at least a threshold number of target documents. For example, multiple target documents linked to by the source document can include a same video content item. The content server 108 can cache a copy of the particular content item, or a portion of the particular content item, on a requesting client device when the source document and target documents are provided to the client device, so that the content item or the portion of the content item is able to be rendered on the client device using the cached copy when the user selects a link to a target document that includes the content item, without the need for a separate request to retrieve the content item.

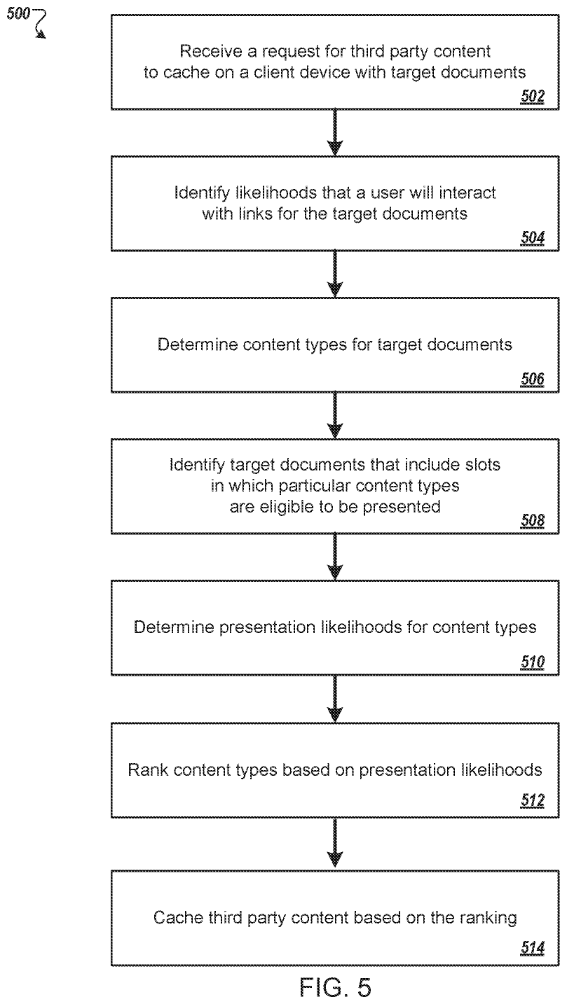

FIG. 5 is a flow chart of an example process 500 for caching third party content. Each of the steps in the process 500 may be performed by a combination of the content server 108 and the source document publisher 114.

At 502, a request is received for third party content to cache on a client device for subsequent presentation with one or more target documents that are displayed in response to user interaction with one or more links presented in a given document. The third party content can be, for example, advertisements or some other type of content. The given document can be, for example, a search results page and the target documents can be search result documents. As another example, the given document can be a content feed (e.g., a social network feed) and the target document can be articles that are linked to by the content feed. For example, the content server 108 can received a request for third party content to cache on the client device 106 for subsequent presentation with one or more search result documents that are displayed in response to user interaction with one or more links presented in a search results page.

At 504, a first likelihood is identified, for each particular link in the one or more links, that a user will interact with the particular link presented in the given document. The first likelihood for a link can be, for example, a click through rate. The click through rate can be an estimated click through rate determined based on historical interaction data for that user or for a plurality of users. For example, a click through rate estimate for a particular link can be based on a particular user's historical data. The user's historical data can indicate, for example, that the user has a tendency to select a first search result link or select links in particular types of content feeds (e.g., social feeds associated with certain other users). Historical data for all users or users in general can also be used. For example, the content server 108 may have previously determined (or may be configured to know) a particular click through rate estimate for each of a predetermined number of search result positions (e.g., the top five search result positions). As another example, the content server 108 can determine a selection estimate for a social feed content item based on how many other users have previously interacted with the social feed content item. In some implementations, interaction likelihoods that are specific to particular documents (e.g., determined based on historical interaction with those documents) can be used.

At 506, one or more content types that are eligible to be presented in slots of the target document are determined for each particular target document in the one or more target documents. The content types can include one or more of content size, text content, image content, video content, or audio content, for example. At least two different content types are eligible to be presented in the slots of the one or more target documents. Some or all of the slots can be associated with a content type tag that indicates the content type that is eligible to be presented in a respective slot, for example. A set of content types associated with a target document can be determined by identifying the content type tags that are included in the target document. As another example, content types associated with the target document can be determined by looking up the target document in a pre-populated mapping database that maps target document references to a set of content types.

If a target document includes more than one instance of a same type of content slot, a separate content type can be identified for each content slot of the same type, with each separate content type being associated with a separate index value that indicates an instance location with the target document of the same type of content slot.

For example, in one implementation, the content server 108 determines different content types that can be presented in content slots of search result documents linked by a search results page. A given search result document may include, for example, an image content slot and a text content slot.

At 508, a set of target documents that each include slots in which the particular content type is eligible to be presented are identified for each particular content type. For example, the content server 108 can generate a data structure which includes information that identifies which content types are included in which target documents. The data structure can include, for example, entries which each include a mapping between a reference to a target document and a content type that is included in the target document. The content server 108 can process the data structure to identify a set of target documents for a particular content type.

At 510, a presentation likelihood is determined for each particular content type of the at least two different content types, based on an aggregation of the first likelihoods of the target documents included in the identified set of target documents for that particular content type. For example, the content server 108 can determine the presentation likelihood for an image content type by adding together the interaction likelihoods for the target documents that include a content slot in which an image content item is eligible to be presented.

In some implementations, the content server 108 can determine a presentation likelihood for a particular content type based on the first likelihoods of the target documents included in the identified set of target documents for the particular content type and on impression likelihoods for slots in which the content type is eligible to be presented that indicate a likelihood that a user will view the content slot when an associated target document is presented. For example, a content slot that is above a fold line may have a higher impression likelihood than a content slot that is below a fold line.

At 512, each particular content type is ranked based on the presentation likelihoods of the two or more different content types. A content type with a higher presentation likelihood can be ranked higher than a content type with a lower presentation likelihood. The content server 108 can, for example, generate a ranking of content types, in order of highest to lowest presentation likelihoods.

At 514, one or more portions of third party content having more highly ranked content type are cached, based on the ranking, prior to interaction with the one or more links at the client device. For example, the content server 108 can cache one or more portions of third party content at the client device 106. Caching can include caching content items that are content types that have presentation likelihoods greater than a predetermined threshold. In some implementations, if no content types have a presentation likelihood greater than the predetermined threshold, no third party content is cached. In some implementations, the threshold may be variable depending on internet connection bandwidth. In some implementations, only a certain percentage or ratio of third party content items are cached, and the number of content types that are cached is dependent on the certain percentage or ratio. As another example, caching can include caching content items in an order corresponding to the presentation likelihoods of the content types of the content items so that content items that are more likely to be presented are ranked before content items that are less likely to be presented. In some implementations, the N highest ranked content types are determined and a content item for each of the N highest ranked content types is cached (where N is a positive integer greater than one).

FIG. 6 shows an example of a computing device 600 and a mobile computing device 650 that may be used to implement the computer-implemented methods and other techniques described herein. The computing device 600 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the inventions described and/or claimed in this document.

The computing device 600 includes a processor 602, a memory 604, a storage device 606, a high-speed interface 608 connecting to the memory 604 and multiple high-speed expansion ports 610, and a low-speed interface 612 connecting to a low-speed expansion port 614 and the storage device 606. Each of the processor 602, the memory 604, the storage device 606, the high-speed interface 608, the high-speed expansion ports 610, and the low-speed interface 612, are interconnected using various busses, and may be mounted on a common motherboard or in other manners as appropriate. The processor 602 can process instructions for execution within the computing device 600, including instructions stored in the memory 604 or on the storage device 606 to display graphical information for a GUI on an external input/output device, such as a display 616 coupled to the high-speed interface 608. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 604 stores information within the computing device 600. In some implementations, the memory 604 is a volatile memory unit or units. In some implementations, the memory 604 is a non-volatile memory unit or units. The memory 604 may also be another form of computer-readable medium, such as a magnetic or optical disk.

The storage device 606 is capable of providing mass storage for the computing device 600. In some implementations, the storage device 606 may be or contain a computer-readable medium, such as a floppy disk device, a hard disk device, an optical disk device, or a tape device, a flash memory or other similar solid state memory device, or an array of devices, including devices in a storage area network or other configurations. The computer program product may also contain instructions that, when executed, perform one or more methods, such as those described above. The computer program product can also be tangibly embodied in a computer- or machine-readable medium, such as the memory 604, the storage device 606, or memory on the processor 602.

The high-speed interface 608 manages bandwidth-intensive operations for the computing device 600, while the low-speed interface 612 manages lower bandwidth-intensive operations. Such allocation of functions is exemplary only. In some implementations, the high-speed interface 608 is coupled to the memory 604, the display 616 (e.g., through a graphics processor or accelerator), and to the high-speed expansion ports 610, which may accept various expansion cards (not shown). In the implementation, the low-speed interface 612 is coupled to the storage device 606 and the low-speed expansion port 614. The low-speed expansion port 614, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 620, or multiple times in a group of such servers. In addition, it may be implemented in a personal computer such as a laptop computer 622. It may also be implemented as part of a rack server system 624. Alternatively, components from the computing device 600 may be combined with other components in a mobile device (not shown), such as a mobile computing device 650. Each of such devices may contain one or more of the computing device 600 and the mobile computing device 650, and an entire system may be made up of multiple computing devices communicating with each other.

The mobile computing device 650 includes a processor 652, a memory 664, an input/output device such as a display 654, a communication interface 666, and a transceiver 668, among other components. The mobile computing device 650 may also be provided with a storage device, such as a micro-drive or other device, to provide additional storage. Each of the processor 652, the memory 664, the display 654, the communication interface 666, and the transceiver 668, are interconnected using various buses, and several of the components may be mounted on a common motherboard or in other manners as appropriate.

The processor 652 can execute instructions within the mobile computing device 650, including instructions stored in the memory 664. The processor 652 may be implemented as a chipset of chips that include separate and multiple analog and digital processors. The processor 652 may provide, for example, for coordination of the other components of the mobile computing device 650, such as control of user interfaces, applications run by the mobile computing device 650, and wireless communication by the mobile computing device 650.

The processor 652 may communicate with a user through a control interface 658 and a display interface 656 coupled to the display 654. The display 654 may be, for example, a TFT (Thin-Film-Transistor Liquid Crystal Display) display or an OLED (Organic Light Emitting Diode) display, or other appropriate display technology. The display interface 656 may comprise appropriate circuitry for driving the display 654 to present graphical and other information to a user. The control interface 658 may receive commands from a user and convert them for submission to the processor 652. In addition, an external interface 662 may provide communication with the processor 652, so as to enable near area communication of the mobile computing device 650 with other devices. The external interface 662 may provide, for example, for wired communication in some implementations, or for wireless communication in other implementations, and multiple interfaces may also be used.

The memory 664 stores information within the mobile computing device 650. The memory 664 can be implemented as one or more of a computer-readable medium or media, a volatile memory unit or units, or a non-volatile memory unit or units. An expansion memory 674 may also be provided and connected to the mobile computing device 650 through an expansion interface 672, which may include, for example, a SIMM (Single In Line Memory Module) card interface. The expansion memory 674 may provide extra storage space for the mobile computing device 650, or may also store applications or other information for the mobile computing device 650. Specifically, the expansion memory 674 may include instructions to carry out or supplement the processes described above, and may include secure information also. Thus, for example, the expansion memory 674 may be provide as a security module for the mobile computing device 650, and may be programmed with instructions that permit secure use of the mobile computing device 650. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. The computer program product contains instructions that, when executed, perform one or more methods, such as those described above. The computer program product can be a computer- or machine-readable medium, such as the memory 664, the expansion memory 674, or memory on the processor 652. In some implementations, the computer program product can be received in a propagated signal, for example, over the transceiver 668 or the external interface 662.

The mobile computing device 650 may communicate wirelessly through the communication interface 666, which may include digital signal processing circuitry where necessary. The communication interface 666 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 668 using a radio-frequency. In addition, short-range communication may occur, such as using a Bluetooth, WiFi, or other such transceiver (not shown). In addition, a GPS (Global Positioning System) receiver module 670 may provide additional navigation- and location-related wireless data to the mobile computing device 650, which may be used as appropriate by applications running on the mobile computing device 650.

The mobile computing device 650 may also communicate audibly using an audio codec 660, which may receive spoken information from a user and convert it to usable digital information. The audio codec 660 may likewise generate audible sound for a user, such as through a speaker, e.g., in a handset of the mobile computing device 650. Such sound may include sound from voice telephone calls, may include recorded sound (e.g., voice messages, music files, etc.) and may also include sound generated by applications operating on the mobile computing device 650.

The mobile computing device 650 may be implemented in a number of different forms, as shown in the figure. For example, it may be implemented as a cellular telephone 670. It may also be implemented as part of a smart-phone 672, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In situations in which the systems, methods, devices, and other techniques here collect personal information (e.g., context data) about users, or may make use of personal information, the users may be provided with an opportunity to control whether programs or features collect user information (e.g., information about a user's social network, social actions or activities, profession, a user's preferences, or a user's current location), or to control whether and/or how to receive content from the content distribution system that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content distribution system.

Although various implementations have been described in detail above, other modifications are possible. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

1. A method comprising:
identifying target documents that have been selected to be delivered to a client device as part of a source document that includes the target documents and presents links that reveal the target documents within the source document, wherein each particular document among the target documents includes content slots that are populated with third party content from a third party content database when the target documents are revealed within the source document;
caching the target documents at the client device as part of the source document prior to interaction with the source document;
identifying at least two different predefined types of third party content that are eligible to populate the content slots of the target documents when the target documents are revealed within the source document in response to user interaction with the links presented in the source document;
prior to user interaction with the links presented in the source document:
receiving, at a content server, a request for third party content to cache on a client device for subsequent presentation in the content slots of the target documents when the target documents are revealed within the source document by way of user interaction with the links presented in the source document;
identifying, for each particular document among the target documents, a first likelihood that the particular target document will be revealed within the source document through user interaction with one of the links presented in the source document;
determining, for each particular type of third party content among the at least two different predefined types of third party content, an aggregated presentation likelihood for the particular type of third party content in the target documents based on an aggregation of the first likelihood identified for each of the target documents having the content slots in which the particular type of third party content is eligible for presentation;
ranking each particular type of third party content based on the aggregated presentation likelihoods of the at least two different types of third party content; and
caching, on the client device and prior to at least one of the target documents being revealed within the source document, one or more portions of third party content having a highest ranked type of third party content among the ranked particular types of third party content based on the ranking.

2. The method of claim 1, wherein the source document comprises search results and the target documents are documents that correspond to the search results.

3. The method of claim 1, wherein the source document comprises a social feed and the target documents comprises articles linked to by the social feed.

4. (canceled)

5. (canceled)

6. The method of claim 1, wherein a given target document includes multiple content slots of a same size and same media type and a content type associated with the content slots indicates the size and a content slot location within the given target document.

7. (canceled)

8. One or more non-transitory computer-readable media having instructions stored thereon that, when executed by one or more processors, cause performance of operations comprising:
identifying target documents that have been selected to be delivered to a client device as part of a source document that includes the target documents and presents links to the target documents, wherein each particular document among the target documents includes content slots that are populated with third party content from a third party content database when the target documents are revealed within the source document;
caching the target documents at the client device as part of the source document prior to interaction with the source document;
identifying at least two different predefined types of third party content that are eligible to populate the content slots of the target documents when the target documents are revealed within the source document in response to user interaction with the links presented in the source document;
prior to user interaction with the links presented in the source document:
receiving, at a content server, a request for third party content to cache on a client device for subsequent presentation in the content slots of the target documents when the target documents are revealed within the source document by way of user interaction with the links presented in the source document;
identifying, for each particular document among the target documents, a first likelihood that the particular target document will be revealed within the source document through user interaction with one of the links presented in the source document;
determining, for each particular type of third party content among the at least two different predefined types of third party content, an aggregated presentation likelihood for the particular type of third party content in the target documents based on an aggregation of the first likelihood identified for each of the target documents having the content slots in which the particular type of third party content is eligible for presentation;
ranking each particular type of third party content based on the aggregated presentation likelihoods of the at least two different types of third party content; and
caching, on the client device and prior to at least one of the target documents being revealed within the source document, one or more portions of third party content having a highest ranked type of third party content among the ranked particular types of third party content based on the ranking.

9. The computer-readable media of claim 8, wherein the source document comprises search results and the target documents are documents that correspond to the search results.

10. The computer-readable media of claim 8, wherein the source document comprises a social feed and the target documents comprises articles linked to by the social feed.

11. (canceled)

12. (canceled)

13. The computer-readable media of claim 8, wherein a given target document includes multiple content slots of a same size and same media type and a content type associated with the content slots indicates the size and a content slot location within the given target document.

14. (canceled)

15. A system comprising:
a third party content database including third party content items provided by third party content providers, each third party content item being of a content type, the content types including one or more of content size, text content, image content, video content, or audio content; and
a content distribution system, including one or more processors, in communication with the third party content database, that:
identifies target documents that have been delivered to a client device as part of a source document that includes the target documents and presents links to the target documents, wherein each particular document among the target documents includes content slots that are populated with third party content from a third party content database when the target documents are revealed within the source document;
caches the target documents at the client device as part of the source document prior to interaction with the source document;
identifies at least two different predefined types of third party content that are eligible to populate the content slots of the target documents when the target documents are revealed within the source document in response to user interaction with the links presented in the source document;
prior to user interaction with the links presented in the source document:
receives a request for third party content to cache on a client device for subsequent presentation in the content slots of the target documents when the target documents are revealed within the source document by way of user interaction with the links presented in the source document;
identifies, for each particular document among the target documents, a first likelihood that the particular target document will be revealed within the source document through user interaction with one of the links presented in the source document;
determines, for each particular type of third party content among the at least two different predefined types of third party content, an aggregated presentation likelihood for the particular type of third party content in the target documents based on an aggregation of the first likelihood identified for each of the target documents having the content slots in which the particular type of third party content is eligible for presentation;
ranks each particular type of third party content based on the aggregated presentation likelihoods of the at least two different types of third party content; and
caches, on the client device and prior to at least one of the target documents being revealed within the source document, one or more portions of third party content having a highest ranked type of third party content among the ranked particular types of third party content based on the ranking.

16. The system of claim 15, wherein the source document comprises search results and the target documents are documents that correspond to the search results.

17. The system of claim 15, wherein the source document comprises a social feed and the target documents comprises articles linked to by the social feed.

18. (canceled)

19. (canceled)

20. The system of claim 15, wherein a given target document includes multiple content slots of a same size and same media type and a content type associated with the content slots indicates the size and a content slot location within the given target document.
